(19) United States
(12) Patent Application Publication
(10) Pub. No.: US 2002/0176124 A1
(43) Pub. Date: Nov. 28, 2002

(54) Linear axially transmissive photon-diffracting device

(76) Inventors: Kent Lawson Wise, Suffolk, VA (US); John Brittain Cooper, Virginia Beach, VA (US); Christian Lee Schoen, Laramie, WY (US)

Correspondence Address: Kent L. Wise, 5112 Dominion Drive, Suffolk, VA, 23435, US

(21) Appl. No.: 09/864,827

(22) Filed: May 23, 2001

(51) Int. Cl. G03H 1/00; G01J 3/40

(52) U.S. Cl. 359/1; 356/305

(57) ABSTRACT

A linear axis spectral analysis system is enclosed. The spectral analysis system utilizes a prism-volume holographic transmission grating-prism combination to achieve a linear axis between input and detector. This design, when held with low thermal expansion materials, is extremely insensitive to temperature and vibration, allowing for enhanced accuracy without the need of temperature control. Further, the spectral analysis system provides the ability for extreme compactness.

### BACKGROUND OF THE INVENTION

I. Field of the Invention

This invention relates generally to methods and apparatus applicable to spectroscopy and, in particular, to a spectrograph whose elements are arranged about a linear axis.

II. Description of Prior Art

In prior art devices, rigid structural members have been employed to mount the optical elements of spectrographs in order to maintain precise axial alignment (Owen, Theodore R., U.S. Pat. No. 4,054,389: Spectrophotometer with photodiode array, Oct. 18, 1977; Anthon, Erik W.: U.S. Pat. No. 6,057,925: Compact spectrometer device, May 2, 2000). In addition, detailed course and fine adjustment have been utilized to carefully produce such alignment in original manufacture and subsequent field use. The structural members are generally aluminum plates, with mounted aluminum optic holders mounted to these plates. Prior art incorporates off linear axis designs (Granger, Edward M.; U.S. Pat. No. 4,895,445: Spectrophotometer, Jan. 23, 1990; Ogusu, Masahiro; Oshima, Shigeru; U.S. Pat. No. 5,917,625: High resolution optical multiplexing and demultiplexing device in optical communication system, Jun. 29, 1999) or 90 degree holographic transmission grating designs (Battey, David E.; Owen, Harry; Tedesco, James M.; U.S. Pat. No. 5,442,439: Spectrograph with multiplexing of different wavelength regions onto a single opto-electric detector array, Aug. 15, 1995). Although solid-mounting structures may help reduce misalignment due to mechanical vibrations and the like, the structure is extremely sensitive to thermal changes during operation. Any thermal expansion of the aluminum base plate will lead to a change in the spectral dispersion collected on the detector (Cooper; John B; Flecher, Philip E.; Welch, William T.; U.S. Pat. No. 5,856,869: Distributed bragg reflector diode laser for Raman excitation and method for use, Jan. 5, 1999). A change in the spectral dispersion on the detector leads to an error in the analysis. Prior art, such as from Process Instruments, Inc. (Smith, Lee M.; Benner, Robert E.; U.S. Pat. No. 6,028,667: Compact and robust spectrograph, Feb. 22, 2000) uses resistive heaters and thermoelectric coolers to control the temperature of their aluminum mounting plates. However, without a complete uniform control of the entire aluminum base plate, thermal gradients can occur, leading to errors in the data. Further, individual mounts cannot be temperature controlled without an extensive and costly means of complex control. Elimination of thermal gradients on these mounts is ultimately impossible due to the required designs of these mounts.

To further exacerbate the problem, multi-channel detectors are mounted directly to the spectrometer housing. These detectors commonly use thermoelectric coolers to minimize thermal noise by reducing the temperature of the detector. By cooling the detector there is a heating of the external housing of the mechanical assembly. As the temperature of the detector is held constant by an external control circuit, the power supplied to the thermoelectric can change significantly depending on the ambient conditions. As the ambient conditions change, the change in current to the thermoelectric can significantly alter the heat load generated by the detector assembly, which is then loaded onto the spectrometer. This is not a linear process, and highly dependent on many environmental parameters. Therefore temperature control of the spectrometer is very difficult.

### SUMMARY OF THE INVENTION

I. General Statement of the Invention

The present invention relates to a spectral dispersing system where all the elements are on a linear axis and held mechanically by materials with low thermal expansion. The spectral dispersing system can be in the form of a spectroscope, spectrograph, or spectrometer and can be used to analyze wavelengths of light in the ultraviolet, visible, and near infrared wavelengths. In this invention, light collected via an aperture is collimated by a lens and then dispersed by a prism-holographic transmission grating-prism combination. The light is then focused onto a multi-channel detector by another lens. Each element of the multi-channel detector yields an electrical response that is proportional to the intensity of a particular wavelength. The analog electrical response for each diode detector element is converted into a digital response using an analog-to-digital converter. The total of all the digital responses for each detector element constitutes a spectral response curve of the input light.

II. Utility of the Invention

The invention allows for the spectral analysis of light. The invention provides the ability for all the elements of the spectral analysis system to be on a linear axis. Due to this linear nature, low thermal expansion materials may be used to mechanically secure the elements. This allows for a spectral analysis system that is highly resistant to data error caused by temperature effects on the system thereby providing extreme stability. An added benefit is compactness. This spectral analysis system can be used for the analysis of any ultraviolet, visible, or near-infrared light input. Applications of the spectral analysis system include passive optical analysis along with active optical analysis systems such as absorption, reflection, transmission, elastic and inelastic scattering systems.

### BRIEF DESCRIPTION OF THE DRAWINGS

FIG. 1 is a diagram of an embodiment of the invention comprising a linear axis spectral analysis system.

FIG. 2 is a schematic view depicting the low-thermal expansion invar rods and their support of the spectral analysis system.

FIG. 3 is a graph of the wavelength stability of the spectral response of the on linear axis system over a temperature range from 23 to 37° C.

FIG. 4 is a graph of the amplitude stability of the spectral response of the on linear axis system over a temperature range from 23 to 37° C.

FIG. 5 shows a series of overlaid spectra depicting the amplitude instability of Raman data taken with a off linear axis spectrometer and CCD detector over an operating temperature range of 28 to 35° C.

FIG. 6 shows a graph of the amplitude instability of FIG. 5.

FIG. 7 shows a graph depicting the variation of data generated by thermal loading of the multi-channel detector onto an off linear axis spectrometer.

FIG. 8 is a diagram of an embodiment of the invention comprising an on linear axis spectral analysis system with a non-fiber optic input.

### REFERENCE NUMERALS IN DRAWINGS

10—fiber-optic

11—collimating optic

12—prism

13—volume holographic transmission grating

14—prism

15—focusing optic

16—multi-channel detector

17—linear axis line

21—invar support rods

22—fiber-optic mount

81—focusing optic

82—aperture

91—fixed plate

92—adjustment plate

93—springs

94—securing screws

95—optical thread mount

96—rod securing screws

101—micrometers

102—two-part adjustment mount

### DESCRIPTION OF THE PREFERRED EMBODIMENTS

### EXAMPLE 1

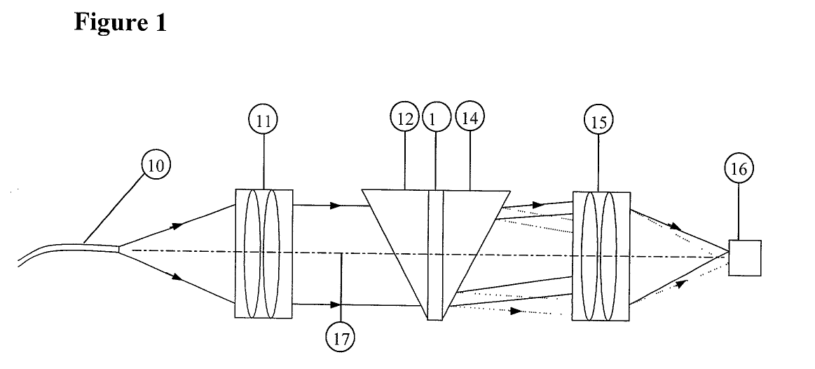

Referring to FIG. 1, in this preferred embodiment of the invention, there are seven main components: a fiber-optic input 10, a collimating lens 11, a prism 12—volume holographic transmission grating 13—prism 14 combination, a focusing lens 15 and a multi-channel detector 16. The linear axis of all the elements is shown 17.

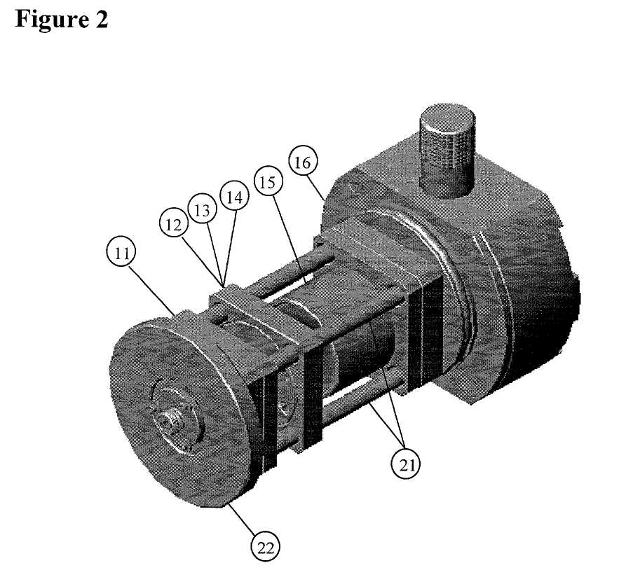

Light exiting the fiber-optic 10 is collimated by the collimating lens 11, dispersed by the prism 12—volume holographic transmission grating 13—prism 14 combination, and focused onto the multi-channel detector 16 by the focusing lens 15. Referring to FIG. 2, the main components of the system are mounted to aluminum holders that are then secured at their four corners by four invar rods 21. The invar rods are secured at the ends via the fiber optic mount 22 and the multi-channel detector 16. The detector assembly 16 is heat sunk via its main body to an external heat sink away from the main components of the system.

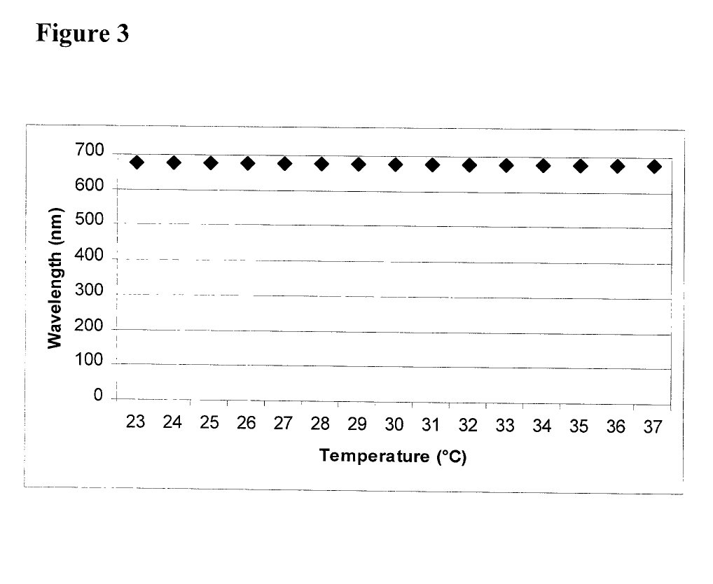

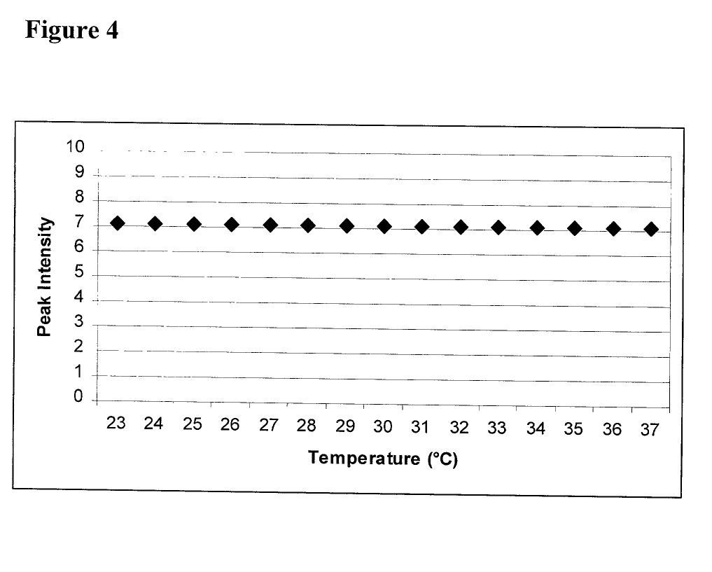

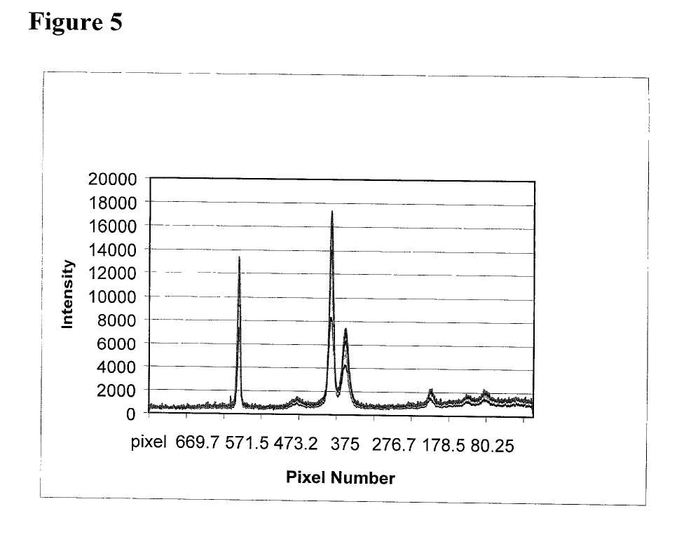

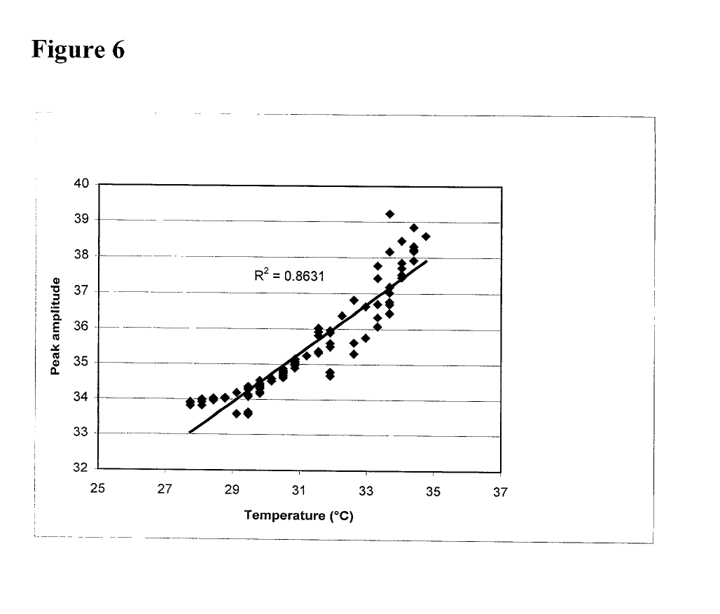

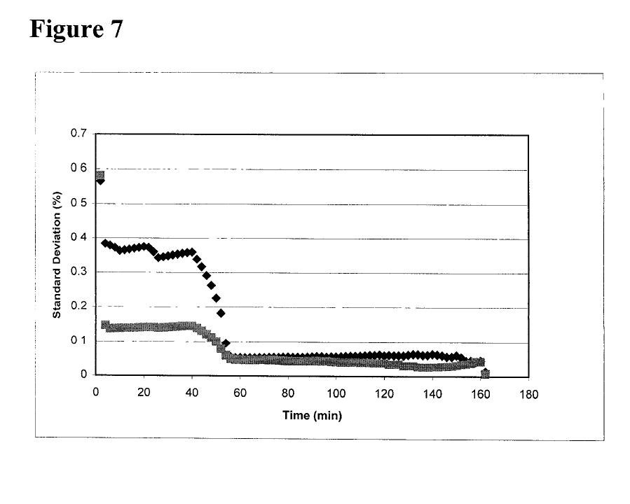

FIG. 3 shows a wavelength stability of the system depicted in FIG. 1 as a function of temperature from 23 to 37° C. FIG. 4 shows the intensity stability of the system depicted in FIG. 1 as a function of temperature from 23 to 37° C. The frequency stability is a measurement of the linearity of the spectrometer as a function of temperature. Any fluctuation in the axis orthogonal to the invar rods results in moving a particular frequency of light from one detector pixel to another horizontally adjacent detector pixel. This frequency shift in turn results in data error due to a horizontal movement of the data on the detector. Intensity stability is also dependent on the position of the elements in the axis of the invar rods. Any change in this direction will quickly modify the number of light photons impinging on a detector pixel. Thermal effects on off linear axis spectrometers tend to have more of an effect on intensity than frequency. FIG. 5 shows the effect of 4° C. on an off linear axis f/2 spectrometer. The f# is a representation of the light gathering capability of the spectrometer, the smaller the number the better the collection. As many of the reflective and transmission grating spectrometers approach f/1.8, the signal amplitude sensitivity to temperature is increased. FIG. 6 shows the graph of the variation of peak amplitude with temperature shown in FIG. 5. FIG. 7 shows the effect of heat load on an off linear axis spectrometer from startup. Standard deviation of amplitude as a function of time is shown.

### EXAMPLE 2

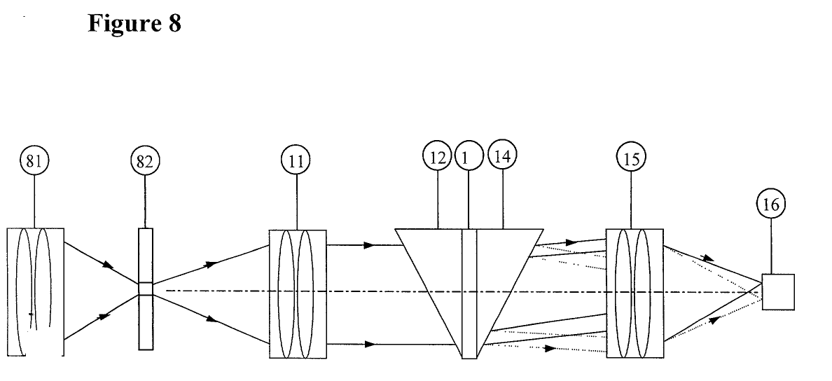

FIG. 8 shows the schematic representation of a free space collection system to the spectrometer system. The light input can be any wavelengths from ultraviolet to near-IR. In this example, the light is focused via a collection lens system 81 to an aperture 82. The aperture controls the ultimate resolution of the system. Light is then collimated via the collimating lens system 11, dispersed by the prism-holographic transmission grating-prism combination 12, 13, 14, respectively, and focused by the focusing lens 15 to the multi-channel detector 16.

Modifications

Specific methods or embodiments discussed are intended to be only illustrative of the invention disclosed by this specification. Variation on the methods or embodiments are readily apparent to a person of skill in the art based upon the teachings of this specification and are therefore intended to be included as part of the inventions disclosed herein.

Examples include an apparatus comprising in combination: a) a light entrance means; b) a light collimation means; c) a light dispersion means; d) a light focusing means; and e) multi-channel detection means; all on a linear axis. Also in the examples is an apparatus in which low thermal expansion rods hold the apparatus elements. An additional example is an apparatus similar to that described in EXAMPLE 1 comprising a spectrograph whose entrance comprises a single fiber optic; a linear array of fiber optics; a single fiber optic mated directly to a slit; or a linear array of fiber optics mated directly to a slit. Another example is an apparatus similar to that described in EXAMPLE 1 comprising a remote probe whose design and configuration is described in documents referenced in this specification.

Another example is an apparatus similar to that in EXAMPLE 1 or EXAMPLE 2, where the analog signal from the detector is converted into a digital signal using the analog-to-digital converter of a standard 16 bit data acquisition card which is plugged into a computer.

Another example is an apparatus similar to that in EXAMPLE 1 or EXAMPLE 2, where the analog signal from the detector is converted into a digital signal using an analog-to-digital converter, which is an integral part of the detector. The resulting digital signal is transmitted to a computer using a standard communications protocol.

Another example is an apparatus similar to that in EXAMPLE 2, where the slit is a linear slit in a vertical dimension. This would allow for push broom sweeping of line images used for spectral imaging applications.

Reference to documents made in the specification is intended to result in such patents or literature being expressly incorporated herein by reference.

Advantages

From the description above, a number of advantages of the invention become evident:

(a) The invention ensures wavelength stability of the optical spectrum. This allows the invention to be used for demanding process control, quality control, and research applications.

(b) The invention ensures amplitude stability of the optical spectrum.

(c) The invention ensures a compact design due to the on linear axis design.

What is claimed is:

1. A device used to separate wavelengths of light in which all optical elements are configured on a linear axis, said device comprising:
An entrance slit through which photons pass;
A collimating lens to receive and collimate the photons that passes through the slit;
A first prism used to receive photons from the collimating lens;
A holographic optical element to receive photons from the first prism and diffract the photons;
A second prism to receive the diffracted photons from the holographic optical element;
A focusing lens to receive the diffracted photons from the second prism and direct the diffracted photons on to a detector.

2. A device used to separate wavelengths of light that uses a prism-grating-prism series combination.

3. The device as defined in claim 1, where in the components comprising the linear axis are mechanically held by low thermal expansion rod(s), the rods extending parallel with but displaced from the optical path.

4. The device as defined in claim 1, wherein the slit is rectangular in dimension.

5. The device as defined in claim 1, wherein the slit is round in dimension.

6. The device as defined in claim 1, wherein the slit is affixed to an optical fiber.

7. The device as defined in claim 1, wherein the slit is an optical fiber.

8. The device as defined in claim 1, wherein the collimating lens is an achromat.

9. The device as defined in claim 1, wherein the collimating lens is an asphere.

10. The device as defined in claim 1, wherein the collimating lens is a multi-element lens.

11. The device as defined in claim 1, wherein the collimating lens is a combination of achromats.

12. The device as defined in claim 1, wherein the collimating lens is a combination of aspheres.

13. The device as defined in claim 1, wherein the collimating lens is a combination of multi-element lenses.

14. The collimating lens as defined in claim 1 has an f-number measured in the range from f/0.5 to f/10.

15. The device as defined in claim 1, wherein the prisms are comprised of BK glass.

16. The device as defined in claim 1, wherein the prisms are comprised of SF glass.

17. The device as defined in claim 1, wherein the holographic optical element is a transmission grating.

18. The device as defined in claim 1, wherein the holographic optical element is a volume holographic grating.

19. The device as defined in claim 1, wherein the holographic optical element has between 100 and 2400 grooves/mm.

20. The device as defined in claim 1, wherein the holographic optical element is comprised of dichromated gelatin.

21. The device as defined in claim 1, wherein the holographic optical element is sealed from the atmosphere.

22. The device as defined in claim 1, where there is a plurality of holographic optical elements.

23. The device as defined in claim 1, wherein the focusing lens is an achromat.

24. The device as defined in claim 1, wherein the focusing lens is an asphere.

25. The device as defined in claim 1, wherein the focusing lens is a multi-element lens.

26. The device as defined in claim 1, wherein the focusing lens is a combination of achromats.

27. The device as defined in claim 1, wherein the focusing lens is a combination of aspheres.

28. The device as defined in claim 1, wherein the focusing lens is a combination of multi-element lenses.

29. The focussing lens as defined in claim 1 has an f-number measured in the range from f/0.5 to f/10.

30. The device in claim 1, wherein the detector is a two-dimensional opto-electric detector array consisting of rows and columns of detector elements.

31. The device in claim 1, wherein the detector is a one-dimensional linear diode array.

32. The device in claim 1, wherein the analyzed light consists of at least one wavelength in the range from 200 nm to 2 microns.
